(19) United States
(12) Patent Application Publication
(10) Pub. No.: US 2022/0023831 A1
(43) Pub. Date: Jan. 27, 2022

(54) COATING MATERIAL FOR PRODUCING AN ADSORBENT, POROUS, FLEXIBLE COATING FOR A HEAT EXCHANGER AND METHOD FOR PRODUCING SAID COATING MATERIAL

(71) Applicant: SORPTION TECHNOLOGIES GMBH, Freiburg (DE)

(72) Inventors: Luigi Calabrese, Ganzirri (IT); Edoardo Proverbio, Messina (IT); Paolo Giovanni Bruzzaniti, Samo (IT); Angelo Freni, Messina (IT); Walter Mittelbach, Freiburg (DE)

(21) Appl. No.: 17/297,605

(22) PCT Filed: Nov. 28, 2019
(86) PCT No.: PCT/EP2019/082820

§ 371 Date: May 27, 2021

(51) Int. Cl. B01J 20/26; B01J 20/10; B01J 20/28; B01J 20/32; C09K 5/14; F28F 13/18

(52) U.S. Cl. CPC B01J 20/262; B01J 20/103; B01J 20/28002; F28F 13/18; B01J 20/3223; B01J 20/3236; C09K 5/14; B01J 20/2803

(57) ABSTRACT

A method for producing a coating material is specified, comprising the following steps: producing a mixture of hydroxyl-terminated siloxane and siloxane having at least three functional hydrides and/or silane having at least three hydrolysable groups; adding an organic solvent to the mixture; homogenizing the mixture; adding an adsorption material to the mixture; and adding a catalyst to the mixture. A coating material according to the invention, a method for coating a device, and a heat exchanger are also specified.

The present invention relates to a method for producing a coating material, to a coating material, to a method for coating a device, and to a heat exchanger.

When optimizing the performance of heat pumps and chillers, the optimization of the heat exchanger plays a critical role. In the case of adsorption chillers and heat pumps, heat exchangers are coated with an adsorption material in order to encourage the adsorption of a gaseous medium at the heat exchanger. Improving the adsorption properties on the heat exchanger is a key factor for optimizing the heat transfer at the heat exchanger and is thus an essential aspect for optimizing the performance of the chiller or heat exchanger.

There is therefore a need for coating materials which can be used to optimize the adsorption performance on the heat exchanger. Zeolites are regarded as a promising group of adsorption materials for the adsorption of water in adsorption chillers and heat pumps. For example, SAPO-34 is regarded as a promising candidate for use as an adsorption material in low-temperature heat engines.

One essential aspect of adsorption optimization is the fixing of the adsorption material to the heat exchanger. On the one hand, adsorption materials can be fixed to the heat exchanger by a binder. The application of the binder facilitates this, but leads to disadvantages with regard to the thermal contact between the adsorption material and the heat exchanger. In addition, often only a limited mechanical durability and strength can be achieved on account of the binder.

It has alternatively been proposed to allow zeolites to crystallize out in situ on the heat exchanger. This leads to almost perfect thermal contact between the zeolites and the heat exchanger surface. However, the process is relatively complex and expensive and requires long treatment times. In addition, only aluminium surfaces can be coated by this method, which is a major limitation in terms of the choice of heat exchangers.

In the light of what has been stated above, the object of the present invention is to achieve an increase in the adsorption performance for as many types of heat exchangers as possible, to improve the performance of adsorption chillers and heat pumps, to improve the service life of the heat exchangers, and to lower the production costs.

This object is achieved by a method for producing a coating material according to claim 1, a coating material according to claim 16, a method for coating a device according to claim 26, and a heat exchanger according to claim 33.

In particular, the object is achieved by a method for producing a coating material, comprising the following steps:
producing a mixture of
   hydroxyl-terminated siloxane and
   siloxane having at least three functional hydrides and/or silane having at least three hydrolysable groups;
adding an organic solvent to the mixture;
homogenizing the mixture;
adding an adsorption material to the mixture; and
adding a catalyst to the mixture.

One essential point of the invention lies in using the mixture of hydroxyl-terminated siloxane and at least trifunctional hydride siloxane or silane as matrix-forming components. The hydroxyl-terminated siloxane serves as a basic monomer for forming a coating matrix, while the trifunctional component (siloxane having at least three functional hydrides and/or silane having at least three hydrolysable groups) serves as a linker for connecting the monomers.

The use of linkers having at least three functional groups is essential here. This enables the formation of a three-dimensional network, which leads to the formation of a closed, porous coating. The matrix-forming silanol and siloxane components ensure the formation of a foam-like, porous structure, in which the adsorption material is embedded.

The production method according to the invention allows the use of a wide range of solid adsorption materials, which can be attached to heat exchanger surfaces with a high bond strength by the silanol and siloxane components.

The composition of the coating material produced according to the invention leads to the formation of a coating having a closed porous structure, which is open to water vapour but closed to liquid water. As a result, corrosion on the surface of a heat exchanger below the coating material can be prevented, which increases the service life of the heat exchanger, particularly in the case of the customary fin-type heat exchangers having aluminium fins and copper tubes. At the same time, the adsorption performance of the adsorption material is not hindered by the silane-siloxane matrix, so that the adsorption performance can be optimized.

With the coating material according to the invention, it is possible to form on almost all common heat exchangers a coating which, owing to the silane-siloxane matrix, is characterized by a very high degree of mechanical flexibility, so that no cracks occur in the coating during deformations on the heat exchanger.

The mixing of the hydroxyl-terminated siloxane with the linkers may take place by simple mechanical stirring, for example using a spoon, a mechanical mixer or a magnetic stirrer.

The molecular weight of the hydroxyl-terminated siloxane is preferably at most 150,000, more preferably at most 18,000. The maximum molecular weight of the hydride-terminated siloxane compound is preferably 10,000, more preferably 1400.

In one preferred embodiment, the hydroxyl-terminated siloxane is produced from silanol-terminated polydimethylsiloxanes, copolymers of silanol-terminated diphenylsiloxane and dimethylsiloxane, silanol-terminated polydiphenylsiloxane, silanol-terminated methylphenylpolysiloxane, silanol-terminated polytrifluoropropylmethylsiloxane, poly(dimethylsiloxane), bis(hydroxyalkyl)-terminated polydimethylsiloxane, hydroxypropyl-terminated polydimethylsiloxane, or a mixture of said substances.

In another preferred embodiment, the siloxane having at least three functional hydrides is formed from: hydride-terminated polydimethylsiloxanes; monodisperse, hydride-terminated polydimethylsiloxane; polymethylhydrosiloxanes, trimethylsiloxy-terminated; methylhydrosiloxane-dimethylsiloxane copolymers, trimethylsiloxy-terminated; methylhydrosiloxane-dimethylsiloxane copolymers, hydride-terminated; methylhydrosiloxane-phenylmethylsiloxane copolymers, hydride-terminated; or copolymers and/or terpolymers of hydride-terminated methylhydrosiloxane and octylmethylsiloxane; or a mixture of said substances.

In another preferred embodiment, the ratio of hydrides to hydroxyl-functionalized siloxane compounds in the mixture has a value between 0 and 4. An optimal structure of the porous silane-siloxane matrix can thus be achieved while at the same time having an excellent bonding of the adsorption material to the matrix. Particular preference is given here to a ratio value between 1.5 and 2.5.

It is also preferred that the organic solvent contains no water or is substantially anhydrous. It has been found that the matrix-forming siloxane and silane components form an emulsion when water is used as a solvent, even if intensive mixing takes place. This leads to large inhomogeneities when the coating is formed. By using an organic, substantially anhydrous solvent, a good homogeneity of the mixture can be achieved. Here, “substantially anhydrous” is to be understood to mean a water content of less than 10%, in particular in the case of ethanol.

The organic solvent preferably consists of ethanol, acetone, tetrahydrofuran (THF) or dimethylformamide (DMF), or of a mixture thereof, particularly preferably a mixture of ethanol and acetone. The mixture of ethanol and acetone is preferred since these substances are harmless to health and inexpensive. Acetone is particularly capable of interacting with the silane-siloxane matrix, which leads to an extension of the polymer chains. The interaction between the various components of the mixture is thus facilitated, and a better mixing of the constituents is achieved. THF and DMF offer the advantage that they provide a high degree of solubility for the constituents of the silane-siloxane matrix.

The viscosity of the mixture can be controlled by the content of the organic solvent. A higher content of organic solvent leads to a low viscosity of the mixture, and vice versa.

In another preferred embodiment, the adsorption material contains solid sorbents having free hydroxyl groups, silica gel, activated carbon, salt hydrates, MOFs (metal organic frameworks) and/or zeolite.

If the adsorption material contains silica gel, preference is given to functionalizing the silica gel before adding it to the mixture. Here, functionalization is understood to mean a surface treatment of the silica gel, during which the number of free hydroxyl groups present on the surface is reduced.

Silica gel, for example in powder form, may in principle also be added to the mixture without being treated. However, only a maximum content of 40-50 wt % of the silica gel can thus be achieved in the coating material.

The functionalization of the silica gel serves to optimize the interaction of the adsorption material with the silane-siloxane matrix. An adsorption material with too high a density of hydroxyl groups on its surface leads to a very strong interaction with the silane-siloxane matrix, which leads to the formation of a heterogeneous composite coating with low cohesion due to a reduced crosslinking of the silane-siloxane matrix. Conversely, using an adsorption material that has too few reactive hydroxyl groups can achieve an optimal crosslinking of the silane-siloxane matrix, but in this case there is insufficient bonding of the adsorption material to the silane-siloxane matrix, so that the adsorption material may detach from the coating material, which may impair the mechanical and chemico-physical efficiency of the coating material itself.

If the silica gel is functionalized before being added to the mixture, the content of the silica gel in the coating material can be increased to up to 80 wt %. The adsorption properties of the coating material can be improved by the high content of adsorption material.

For the functionalization, the silica gel may be treated with a tetraethyl orthosilicate solution (50% in water) for 2 to 12 hours (preferably 4 hours) at room temperature. At the end of the process, the silica gel is filtered and then is dried in the oven for 24 hours in order to obtain the functionalized silica gel powder.

If zeolite is used as the adsorption material, an adsorption material content of up to 95 wt % can in principle be achieved even without functionalization. A mixture of silica gel and zeolites may also be used in order to optimize the coating material for relevant applications.

The MOFs, which can also be used as an adsorption material, are understood to mean the known microporous materials which are routine in the art and which are constructed from inorganic structural units and organic molecules as connecting elements between the inorganic structural units.

In another preferred embodiment, the method comprises adding a thermally conductive filler to the mixture. The thermal conductivity of the coating material can be increased as a result. This in turn leads to an improved thermal efficiency of the heat exchanger, even in the case of high layer thicknesses of the coating material.

It is preferred here that the thermally conductive filler contains graphite, in particular graphite powder, carbon nanotubes, graphene, copper powder and/or aluminium powder. Graphite powder offers the advantages of low weight and low costs.

In another preferred embodiment, the catalyst contains bis(2-ethylhexanoate)tin, dibutyldilauryltin, zinc octoate, iron octoate and/or metal salt.

In another preferred embodiment, the step of adding the adsorption material to the mixture comprises a stirring of the mixture for two minutes or more. It is also preferred that the step of adding the catalyst to the mixture comprises a stirring of the mixture for two minutes or more. It can thus be ensured that the mixture is homogeneous, which leads to improved properties of the coating material. The stirring may take place manually or by means of conventional mechanical mixing devices.

In another embodiment, the proportion of the catalyst in the mixture is between 0.1 and 6 wt %, preferably between 0.1 and 5 wt %, more preferably between 0.1 and 3 wt %. The catalyst is added to the mixture in order to encourage a dehydrogenating reaction between the matrix-forming components and between the matrix-forming components and the adsorption material and thus to encourage the formation of a porous coating after application.

It is also preferred that the proportion of the thermally conductive filler in the mixture is less than 20 wt %, preferably 7.5 wt %. An effective contribution to the thermal conductivity of the coating material can thus be achieved.

The object of the invention is also achieved by a coating material which is preferably produced by the method described above and which consists of:
2 to 40 wt % hydroxyl-terminated siloxane,
less than 20 wt % siloxane having at least three functional hydrides, and/or less than 10 wt % silane having at least three hydrolysable groups,
10 to 70 wt % of an organic solvent,
5 to 85 wt % of an adsorption material,
0.1 to 6 wt %, preferably between 0.1 and 5 wt %, more preferably between 0.1 and 3 wt % of a catalyst, and
optionally less than 20 wt %, preferably 7.5 wt % of a thermally conductive filler,
   the remainder being unavoidable impurities.

The specified proportions by weight of the coating material relate to the composition of the coating material prior to application.

The coating material according to the invention offers numerous advantages. The use of the coating material is not limited to specific geometries or materials of the device to be coated and can be used for example on devices made of steel, copper, aluminium, plastic or graphite.

The coating material can be used to create a porous and mechanically flexible coating. For the adsorption material, a large group of suitable materials can be used, which can be optimally selected depending on the intended use.

With the coating material according to the invention, coatings can be formed in almost any desired thickness, without impairing the adsorption properties. In the case of conventional coating materials, there are limits on the layer thickness due to the limited diffusion of water vapour into the innermost regions of the coating. This leads to a significant reduction in the efficiency of the heat exchanger when the layer thickness is increased. In order to overcome this disadvantage, small layer thicknesses are traditionally chosen. However, high thicknesses permit larger amounts of adsorption material and thus enable a greater performance of the heat pump, provided that vapour diffusion is not hindered.

The porous structure of the coating material according to the invention makes it possible to produce coatings with a high layer thickness without impairing the diffusion of water vapour in the interior of the coating itself. With the coating material according to the invention, therefore, the advantages of high layer thicknesses in terms of adsorption efficiency can be combined with the advantages of thin layer thicknesses in terms of the adsorption kinetics.

The coating material according to the invention has a high degree of mechanical flexibility, which can absorb the tensile stresses generated during a coating process and thus improves the adhesion properties of the coating material. It is thus also possible, with the coating material according to the invention, to increase the stability of a coating with regard to thermomechanical stresses to which the materials on a heat exchanger are exposed during the life cycle in adsorption heat pumps. In addition, the high degree of flexibility of the coating material according to the invention compared to conventional materials makes it possible to reduce the damage that occurs during transport, during installation or in mobile heat pump modules.

Overall, the coating material according to the invention is characterized by a high resistance, both in terms of mechanical resistance and in terms of electrochemical and hygrothermal stability.

As described above, the ratio of hydride to hydroxyl-functionalized siloxane compounds in the mixture is set to a value between 0 and 4, more preferably to a value between 1.5 and 2.5, in order to ensure an optimal matrix formation and crosslinking with the adsorption material.

It may be preferred that the coating material contains 2 to 20 wt %, more preferably 2 to 15 wt % hydroxyl-terminated siloxane. It may also be preferred that the coating material contains less than 15 wt %, more preferably less than 10 wt % siloxane having at least three functional hydrides, and/or less than 7 wt % silane having at least three hydrolysable groups. The amount of adsorption material in the coating material may preferably lie in a range between 10 wt % and 60 wt %, more preferably between 20 wt % and 50 wt %, even more preferably between 25 wt % and 40 wt %.

The coating material according to the invention contains 10 to 70 wt % of an organic solvent. A small solvent content leads to an excessively high viscosity of the coating material, which in the extreme case leads to the situation where dip-coating is no longer possible. In contrast, an excessively high solvent content leads to the formation of a pore-free coating, which impairs the adsorption properties of the coating material. For this reason, the proportion of solvent in the coating material is between 10 and 70 wt %, preferably between 40 and 50 wt %.

The proportion of adsorption material depends on the respective use. As described above, an adsorption material content of up to 80 wt % can be achieved with functionalized silica gel. Adsorption materials such as activated carbon or salt hydrates can also reach a proportion of up to 80 wt % in the coating material.

The amount of catalyst lies between 0.1 and 6 wt %, preferably between 0.1 and 5 wt %, more preferably between 0.1 and 3 wt %, in order to achieve both a sufficient pot life and good application properties. Due to the relatively low dose of catalyst, pot lives of up to 10 minutes can be achieved, which is a considerable improvement over conventional comparable coating materials, the pot lives of which are usually 2 minutes or less.

The amount of catalyst also influences the porosity of the coating. As described above, the catalyst triggers a dehydrogenating reaction between the matrix-forming components and between the matrix-forming components and the adsorption material. The resulting gases, predominantly hydrogen, cause the formation of gas bubbles in the coating material, which influence the structure of the coating material. The result is a foam-like, porous structure, the porosity of which can be influenced by the amount of catalyst.

The coating material according to the invention also preferably has the substance composition properties which have been mentioned in connection with the production method described above and which will be reported again below. The resulting advantages respectively correspond to the advantages described above.

In one preferred embodiment, the hydroxyl-terminated siloxane is produced from silanol-terminated polydimethylsiloxanes, copolymers of silanol-terminated diphenylsiloxane and dimethylsiloxane, silanol-terminated polydiphenylsiloxane, silanol-terminated methylphenylpolysiloxane, silanol-terminated polytrifluoropropylmethylsiloxane, poly(dimethylsiloxane), bis(hydroxyalkyl)-terminated polydimethylsiloxane, hydroxypropyl-terminated polydimethylsiloxane, or a mixture of said substances.

In another preferred embodiment, the siloxane having at least three functional hydrides is formed from: hydride-terminated polydimethylsiloxanes; monodisperse, hydride-terminated polydimethylsiloxane; polymethylhydrosiloxanes, trimethylsiloxy-terminated; methylhydrosiloxane-dimethylsiloxane copolymers, trimethylsiloxy-terminated; methylhydrosiloxane-dimethylsiloxane copolymers, hydride-terminated; methylhydrosiloxane-phenylmethylsiloxane copolymers, hydride-terminated; or copolymers and/or terpolymers of hydride-terminated methylhydrosiloxane and octylmethylsiloxane; or a mixture of said substances.

In addition, the organic solvent preferably contains no water or is substantially anhydrous. The organic solvent preferably consists of ethanol, acetone, tetrahydrofuran (THF) or dimethylformamide (DMF), or of a mixture thereof, particularly preferably a mixture of ethanol and acetone.

It is also preferred that the adsorption material contains silica gel, activated carbon, salt hydrates, MOFs and/or zeolite. The adsorption material more preferably contains silica gel which is functionalized before being added to the mixture.

It is also preferred that the thermally conductive filler contains graphite, in particular graphite powder, carbon nanotubes, graphene, copper powder and/or aluminium powder.

It is also preferred that the catalyst contains bis(2-ethylhexanoate)tin, dibutyldilauryltin, zinc octoate, iron octoate and/or metal salt.

Also specified in the context of the invention is a method for coating a device, comprising the following steps:
providing a coating material produced by the method described above or a coating material as described above;
applying the coating material to the device in order to form a coating;
drying the coating; and
curing the coating.

The method according to the invention for coating a device can also be carried out quickly and inexpensively by industrial coating methods. The layer thickness of the coating is almost freely selectable and can easily be set by means of the application method and the viscosity of the coating material.

The application of the coating material may preferably take place by means of spraying, dip-coating or pouring. Depending on the application method, the viscosity of the coating material can be suitably adapted via the concentration of the organic solvent. A dip-coating may also take place in multiple successive dipping steps.

The drying of the coating preferably takes place at room temperature for one hour or longer. By virtue of the drying process, the formation of defects and macrobubbles during the curing of the coating can be avoided. Approximately 30% of the organic solvent evaporates during the drying process.

It is also preferred that the curing of the coating takes place at a temperature between 50° C. and 100° C., preferably at 80° C., for 24 hours or longer. Lower temperatures during the curing encourage small bubbles in the coating and porous coatings of high density. This results in a closed cell structure. Higher temperatures during the curing encourage large bubbles and porous coatings of low density.

After the curing, a post-curing step may be carried out at a temperature between 60° C. and 150° C. for 3 to 48 hours, preferably at 90° C. for 3 hours under vacuum; or at room temperature for 2 weeks. A complete outgassing of all non-reacting compounds can thus be achieved.

The curing steps—that is to say the curing of the coating and/or the post-curing step—are preferably carried out at a temperature between 40° C. and 110° C. This improves the formation of bonds in the silane-siloxane matrix and allows a faster formation of the porous structure.

In addition, the thickness of the coating is preferably between 0.05 mm and 2.0 mm. At these layer thicknesses, optimal heat transfer and water vapour diffusion can be achieved.

Also specified in the context of the invention is a heat exchanger having a coating made of a coating material produced by the above method or of a coating material as described above, wherein the heat exchanger is preferably coated by a method for coating a device as described above. The heat exchanger according to the invention is characterized by good adsorption properties, high mechanical stability, low susceptibility to corrosion, and inexpensive production.

Further advantageous embodiments of the invention will emerge from the dependent claims.

It should be noted once again that the features and advantages of the mixture from which the coating material is produced, as described in the context of the method according to the invention, also apply to the coating material according to the invention. Likewise, the described features and advantages of the coating material, in particular the details regarding the composition thereof, are applicable to the method for producing the coating material.

The invention will also be described below with regard to further features and advantages, which will be explained in greater detail on the basis of the figures.

In the figures:

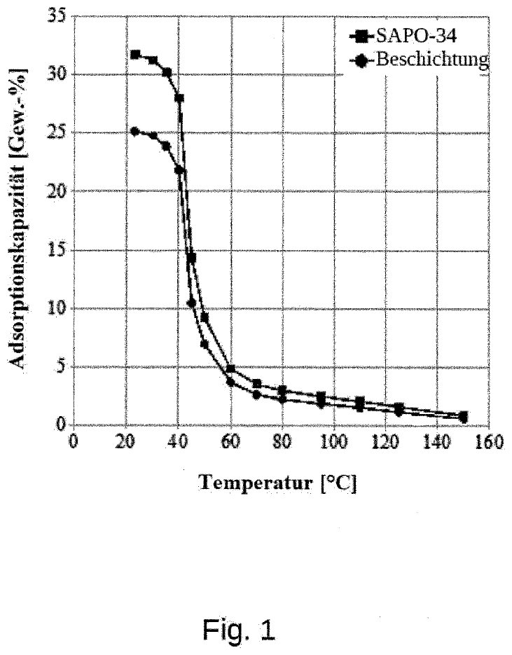

FIG. 1 shows adsorption curves of a coating material according to the invention compared to a reference adsorption material.

In order to produce a coating material according to the invention, 2 to 40 wt % hydroxyl-terminated siloxane and less than 20 wt % siloxane having at least three functional hydrides, and also less than 10 wt % silane having at least three hydrolysable groups are mixed with one another in a first step. Here and also below, the proportions by weight always relate to the total mass of the end product. The hydroxyl-terminated siloxane is a monomer which is provided for forming a silicon-containing, porous matrix. The hydride-terminated siloxane and the silane provided with hydrolysable groups serve as a hardening agent or crosslinker for the hydroxyl-terminated siloxane.

In order to achieve an optimal crosslinking of the matrix-forming components, the amounts of the monomer and of the hardening agent are selected such that the ratio of hydrides to hydroxyl-functionalized siloxane compounds has a value between 0 and 4. A value between 1.5 and 2.5 is particularly preferred.

In a further step, between 10 and 70 wt %, preferably between 40 and 50 wt %, of an anhydrous, organic solvent are added to the mixture. The mixture is homogenized, for example by means of mechanical stirring. The homogenization of the mixture is facilitated as a result of using an anhydrous organic solvent.

Thereafter, an adsorption material is added to the mixture, as well as optionally a thermally conductive filler. The mixture is then mixed until a homogeneous mass is achieved. A mechanical stirring process for two minutes is usually sufficient for this.

Finally, a catalyst is added to the mixture with vigorous stirring for approximately one to two minutes. The coating material thus produced can then be bottled or applied directly to a heat exchanger.

The application of the coating material to a heat exchanger may take place by means of spraying, dip-coating, pouring, or another method. After being applied in the desired thickness, a drying step is carried out at room temperature. During this, approximately 30% of the organic solvent evaporates. Approximately one hour is usually sufficient for the drying step in order to achieve the desired solvent evaporation.

In order to achieve the final curing and bubble formation in the interior of the coating, a curing step is carried out at low temperature, in the range between 50° C. and 100° C., preferably 80° C., for 24 hours. Low curing temperatures encourage the formation of small bubbles and therefore coatings with small pore diameters and high density. High curing temperatures encourage the formation of large bubbles and therefore porous coatings with large pore diameters and low density.

A post-curing in the temperature range between 60° C. and 150° C. may be carried out for 6 to 48 hours in order to ensure a complete outgassing of all non-reacting compounds. Alternatively, albeit less effectively, storage at room temperature for 2 weeks may also be carried out for post-curing purposes as an inexpensive alternative.

FIG. 1 shows measured adsorption curves of an above-described coating according to the invention containing SAPO-34 as the adsorption material compared to that of pure SAPO-34 powder. In each case, the adsorption capacity in wt % is plotted against temperature. The adsorptive used was water at a pressure of 11 mbar. The coating exhibits an excellent adsorbability with an adsorption curve very similar to that of pure SAPO-34. The maximum adsorption capacity in the coating is 25.2 wt %. This value is achieved with a coating containing 80 wt % SAPO-34 as the adsorption material in the coating material, and is approximately 20% lower than the maximum adsorption capacity of pure SAPO-34 powder (31.7 wt %). This proves the excellent adsorption properties that can be achieved with the coating material according the invention.

The substantially matching course of the adsorption curves in FIG. 1 additionally shows that the crosslinking of the silanol-siloxane matrix does not significantly influence the adsorption capacity of the coating material, but instead primarily stabilizes the structure in the coating so that high efficiencies can be achieved when using the coating material on heat exchangers. These properties can also be achieved with the other adsorption materials (not shown here), which proves the high degree of flexibility of the coating material according to the present invention.

The coating material according to the invention is suitable for a wide range of uses in a large temperature range and can be used for example in the field of dehumidification, air conditioning or adsorption of water vapor. The adsorption material can be suitably selected depending on the field of application.

In addition, although the coating material is hydrophilic to water vapor, it is hydrophobic to water in the liquid phase. Thanks to these properties, the coating material according to the invention is optimally suited to systems in which water condensation may occur, since both corrosion problems and biofouling problems can be prevented.

1. Method for producing a coating material, comprising the following steps:
producing a mixture of
hydroxyl-terminated siloxane and
siloxane having at least three functional hydrides and/or silane having at least three hydrolysable groups;
adding an organic solvent to the mixture;
homogenizing the mixture;
adding an adsorption material to the mixture; and
adding a catalyst to the mixture.

2. Method according to claim 1, wherein the hydroxyl-terminated siloxane is produced from silanol-terminated polydimethylsiloxanes, copolymers of silanol-terminated diphenyl siloxane and dimethylsiloxane, silanol-terminated polydiphenylsiloxane, silanol-terminated methylphenylpolysiloxane, silanol-terminated polytrifluoropropylmethylsiloxane, poly(dimethylsiloxane), bis(hydroxyalkyl)-terminated polydimethylsiloxane, hydroxypropyl-terminated polydimethylsiloxane, or a mixture of said substances.

3. Method according to claim 1, wherein the siloxane having at least three functional hydrides is formed from: hydride-terminated polydimethylsiloxanes;
monodisperse, hydride-terminated polydimethylsiloxane; polymethylhydrosiloxanes, trimethylsiloxy-terminated; methylhydrosiloxane-dimethylsiloxane copolymers, trimethylsiloxy-terminated; methylhydrosiloxane-dimethylsiloxane copolymers, hydride-terminated;
methylhydrosiloxane-phenylmethylsiloxane copolymers, hydride-terminated; or copolymers and/or terpolymers of hydride-terminated methylhydrosiloxane and octylmethylsiloxane; or a mixture of said substances.

4. Method according to claim 1, wherein the ratio of hydrides to hydroxyl-functionalized siloxane compounds in the mixture has a value between 0 and 4.

5. Method according to claim 1, wherein the organic solvent contains no water or is substantially anhydrous.

6. Method according to claim 1, wherein the organic solvent consists of ethanol, acetone, tetrahydrofuran (THF) or dimethylformamide (DMF), or of a mixture thereof, preferably a mixture of ethanol and acetone.

7. Method according to claim 1, wherein the adsorption material contains solid sorbents having free hydroxyl groups, silica gel, activated carbon, salt hydrates, MOFs (metal organic frameworks) and/or zeolite.

8. Method according to claim 1, wherein the adsorption material contains silica gel which is functionalized before being added to the mixture.

9. Method according to claim 1, which comprises adding a thermally conductive filler to the mixture.

10. Method according to claim 9, wherein the thermally conductive filler contains graphite, in particular graphite powder, carbon nanotubes, graphene, copper powder and/or aluminium powder.

11. Method according to claim 1 any one of the preceding claims, wherein the catalyst contains bis(2-ethylhexanoate)tin, dibutyldilauryltin, zinc octoate, iron octoate and/or metal salt.

12. Method according to claim 1 any one of the preceding claims, wherein the step of adding the adsorption material to the mixture comprises a stirring of the mixture for two minutes or more.

13. Method according to claim 1 any one of the preceding claims, wherein the step of adding the catalyst to the mixture comprises a stirring of the mixture for two minutes or more.

14. Method according to claim 1 any one of the preceding claims, wherein the proportion of the catalyst in the mixture is between 0.1 and 6 wt %, preferably between 0.1 and 5 wt %, more preferably between 0.1 and 3 wt %.

15. Method according to claim 9, wherein the proportion of the thermally conductive filler in the mixture is less than 20 wt %, preferably 7.5 wt %.

16. Coating material, preferably produced by a method according to claim 1, consisting of:
2 to 40 wt % hydroxyl-terminated siloxane,
less than 20 wt % siloxane having at least three functional hydrides, and/or less than 10 wt % silane having at least three hydrolysable groups,
10 to 70 wt % of an organic solvent,
5 to 85 wt % of an adsorption material,
0.1 to 6 wt %, preferably between 0.1 and 5 wt %, more preferably between 0.1 and 3 wt % of a catalyst, and
optionally less than 20 wt %, preferably 7.5 wt % of a thermally conductive filler, the remainder being unavoidable impurities.

17. Coating material according to claim 16, wherein the hydroxyl-terminated siloxane is produced from silanol-terminated polydimethylsiloxanes, copolymers of silanol-terminated diphenylsiloxane and dimethylsiloxane, silanol-terminated polydiphenylsiloxane, silanol-terminated methylphenylpolysiloxane, silanol-terminated polytrifluoropropylmethylsiloxane, poly(dimethylsiloxane), bis(hydroxyalkyl)-terminated polydimethylsiloxane, hydroxypropyl-terminated polydimethylsiloxane, or a mixture of said substances.

18. Coating material according to claim 16, wherein the siloxane having at least three functional hydrides is formed from: hydride-terminated polydimethylsiloxanes; monodisperse, hydride-terminated polydimethylsiloxane;
polymethylhydrosiloxanes, trimethylsiloxy-terminated; methylhydrosiloxane-dimethylsiloxane copolymers, trimethylsiloxy-terminated; methylhydrosiloxane-dimethylsiloxane copolymers, hydride-terminated; methylhydrosiloxane-phenylmethylsiloxane copolymers, hydride-terminated; or copolymers and/or terpolymers of hydride-terminated methylhydrosiloxane and octylmethylsiloxane; or a mixture of said substances.

19. Coating material according to claim 16, wherein the ratio of hydrides to hydroxyl-functionalized siloxane compounds in the mixture has a value between 0 and 4.

20. Coating material according to claim 16, wherein the organic solvent contains no water or is substantially anhydrous.

21. Coating material according to claim 16, wherein the organic solvent consists of ethanol, acetone, tetrahydrofuran (THF) or dimethylformamide (DMF), or of a mixture thereof, preferably a mixture of ethanol and acetone.

22. Coating material according to claim 16, wherein the adsorption material contains silica gel, activated carbon, salt hydrates, MOFs and/or zeolite.

23. Coating material according to claim 16, wherein the adsorption material contains silica gel, which is functionalized before being added to the mixture.

24. Coating material according to claim 16, wherein the thermally conductive filler contains graphite, in particular graphite powder, carbon nanotubes, graphene, copper powder and/or aluminium powder.

25. Coating material according to claim 16, wherein the catalyst contains bis(2-ethylhexanoate)tin, dibutyldilauryltin, zinc octoate, iron octoate and/or metal salt.

26. Method for coating a device, in particular a heat exchanger, comprising the following steps:
providing a coating material produced by a method according to claim 1;
applying the coating material to the device in order to form a coating;
drying the coating; and
curing the coating.

27. Method according to claim 26, wherein the application of the coating material takes place by means of spraying, dip-coating or pouring.

28. Method according to claim 26, wherein the drying of the coating takes place at room temperature for one hour or longer.

29. Method according to claim 26, wherein the curing of the coating takes place at a temperature between 50° C. and 100° C., preferably at 80° C., for 24 hours or longer.

30. Method according to claim 26, wherein, after the curing, a post-curing step is carried out at a temperature between 60° C. and 150° C. for 3 to 48 hours, preferably at 90° C. for 3 hours under vacuum; or at room temperature for 2 weeks.

31. Method according to claim 26, wherein the curing steps are carried out at a temperature between 40° C. and 110° C.

32. Method according to claim 26, wherein the thickness of the coating is between 0.05 mm and 2.0 mm.

33. Heat exchanger having a coating made of a coating material produced by a method according to claim 1.

34. Method for coating a device, comprising the following steps:
providing a coating material according to claim 16;
applying the coating material to the device in order to form a coating;
drying the coating; and
curing the coating.

35. Heat exchanger having a coating formed of a coating material according to claim 16.

36. Heat exchanger coated by the method according to claim 26.
